(19) United States
(12) Patent Application Publication
(10) Pub. No.: US 2009/0282693 A1
(43) Pub. Date: Nov. 19, 2009

(54) SHAVER CLEANER AND SHAVER SYSTEM

(75) Inventors: Hiroyasu Kitamura, Hirakata (JP); Seiichi Iwao, Inukami (JP)

Correspondence Address: GREENBLUM & BERNSTEIN, P.L.C., 1950 ROLAND CLARKE PLACE, RESTON, VA, 20191, US

(73) Assignee: Panasonic Electric Works Co., Ltd., Osaka (JP)

(21) Appl. No.: 12/374,085

(22) PCT Filed: Jul. 12, 2007
(86) PCT No.: PCT/JP2007/063890

§ 371 Date: Jan. 16, 2009

(30) Foreign Application Priority Data
Jul. 20, 2006 (JP) 2006-197976

(51) Int. Cl. A45D 27/46; F26B 3/347

(52) U.S. Cl. 34/247; 30/537

(57) ABSTRACT

DC 5V shared with a shaver is inputted into a step-up circuit of a cleaner from a terminal of an AC adapter. When an oscillation circuit turns on/off an FET, the voltage is stepped up by using a choke coil, and the charge is accumulated in a capacitor. By using DC 24V of the stet-up result outputted from the capacitor, an electromagnetic induction heating circuit allows an FET to turn on/off the current flowing through a coil, the blade edge of the shaver is induction-heated. In this case, by applying a trigger pulse of the oscillation circuit through an inverter to the FET, the duty factor of the step-up circuit is high, and that of the electromagnetic induction heating circuit is low.

### TECHNICAL FIELD

The present invention relates to a shaver cleaner for cleaning off hair and skin tissues adhered to the blade edge of a shaver, and a shaver system including a power supply adapter capable of supplying power to the shaver cleaner.

### BACKGROUND ART

A cleaner for cleaning off hair and skin tissues adhered to the blade edge of a shaver is presented in, for example, Patent Documents 1 and 2. It is described in Patent Documents 1 and 2 that cleaning liquid is supplied to clean the blade edge and thereafter air is blown by a fan to perform drying as well. By using such a cleaner, the above described hair and skin tissues can be appropriately cleaned off to keep the blade edge clean.

On the other hand, Patent Documents 3 and 4 propose a shaver system configured to be contactless by supplying power to a shaver mounted on a charger (base) by means of electromagnetic induction, in which the shaver is set on the charger with its upside down after the blade edge is washed with water to heat and dry the blade edge by the electromagnetic induction heating. In such configuration, disinfection is performed by the heat generated by the blade edge itself, thereby keeping the blade edge clean.

Accordingly, there is proposed a cleaner in which cleaning is performed by using the above described technique and drying is performed by induction heating. Such a configuration is shown in FIG. 3A. FIG. 3A is a block diagram of a shaver system on which the present invention is founded. The shaver system S is configured to include, in addition to a shaver 1, a cleaner 2 and an AC adapter 3 which enable to perform the above described cleaning and drying as well as charging of the shaver 1. Such shaver system S is typically configured that the terminal 3a of the AC adapter 3 is connected to the cleaner 2 and shaver 1 is appropriately charged by simply being mounted on the cleaner 2.

However, as a backup system for the case in which the secondary battery in the shaver 1 is fully discharged, and in order for the adaptation to a long term travel, the adapter 3 can also be used by connecting the terminal 3a thereof directly to the shaver 1 as shown in FIG. 3B. In this configuration, a transformer is contained in the AC adapter 3, and the commercial power supply side and the load side are isolated. Further, after the conversion by the above described transformer, the voltage is regulated into a constant voltage by a switching power supply and is outputted so that the AC adapter 3 provides a world wide compatible adapter capable of constantly outputting DC 5V for an input of AC 100V to 240V. In addition to that, a power supply adapter compatible with a DC input can be used for automobile use.

On the other hand, in the above described cleaner 2, the input voltage from the above described terminal 3a is supplied to the shaver 1 via a power supply line 4 for use in the charging, and also supplied to a cleaning circuit 5 for use in the cleaning of the blade edge 1a of the shaver 1. The cleaning circuit 5 is configured to include a pump and a valve for circulating the cleaning liquid in a cleaning bath 6 and a circuit for controlling the driving of them. The input voltage from the above described terminal 3a is stepped up at a step-up circuit 7 and thereafter is supplied to an electromagnetic induction heating circuit 8. The electromagnetic induction heating circuit 8 creates a high-frequency signal necessary for the electromagnetic induction heating of the above described blade edge 1a from the stepped up voltage. Then, the high-frequency signal is supplied to the blade edge 1a after being cleaned from the electromagnetic induction heating transformer 9.

Since, when drying the above described blade edge 1a by electromagnetic induction heating, the loss by a switch element such as an FET for turning on/off the current to the coil L1 of the electromagnetic induction heating transformer 9, which produces an induction field, will increase if the power supply voltage of the electromagnetic induction heating circuit 8 is low, the above described step-up circuit 7 is provided to suppress such losses. An improvement of heating efficiency by raising the power supply voltage at the step-up circuit upon performing electromagnetic induction heating is shown by for example Patent Document 5. In this respect, although raising the DC voltage itself supplied from the AC adapter 3 will eliminate the need of such step-up circuit 7, a step-down circuit will be needed on the shaver 1 side thereby causing the upsizing of the shaver 1.

FIG. 4 is an electric circuit diagram showing a typical conventional art of the above described step-up circuit 7 and the electromagnetic induction heating circuit 8. In the configuration of FIG. 4, configurations corresponding to those of the above described FIG. 3 are denoted by like reference characters.

In FIG. 4, in the step-up circuit 7, the DC 5V provided from the terminal 3a of the above described AC adapter 3 serves as the power supply input. A series circuit of a choke coil L2 and an FET Q1 which is a switch element is connected between terminals 3a. An oscillation circuit OS1 is connected to the gate of the FET Q1 via a gate resistance R1. Then, a series circuit of a diode D1 and a capacitor C1 is connected between the source and the drain of the FET Q1. When a trigger pulse which is supplied to the gate of the FET Q1 from the oscillation circuit OS1 via the gate resistance R1 becomes a high level, the FET Q1 turns on so that excitation energy is accumulated in the choke coil L2. Then, when the FET Q1 turns off, a voltage generated at the choke coil L2 is added to the 5V from the terminal 3a to be outputted, and the voltage is taken out from the junction between the choke coil L2 and the FET Q1 via the diode D1 to be accumulated in the capacitor C1. In this way, for the above described input voltage of DC 5V, for example DC 24V is outputted from across the terminals of the capacitor C1 which is made up of an electrolysis capacitor and serves as the power supply of the electromagnetic induction heating circuit 8.

In the electromagnetic induction heating circuit 8, the above described capacitor C1 serves as the power supply. A series circuit of a coil L1 and an FET Q2 which is a switch element is connected between the terminals. An oscillation circuit OS1 is connected to the gate of the FET Q2 via a gate resistance R2. A capacitor C2 for resonance is connected in parallel to the coil L1. When a trigger pulse, which is provided to the gate of the above described FET Q2 from the oscillation circuit OS1 via the gate resistance R2, becomes a high level, the FET Q2 turns on so that eddy current is generated in the above described blade edge 1a by electromagnetic induction causing the blade edge 1a to generate heat. It is shown for example in Patent Document 6 that the same oscillation circuit OS1 is shared by the step-up circuit 7 and the electromagnetic induction heating circuit 8.

In the step-up circuit 7 configured as described above, the relationship between the input voltage Vin into the terminal 3a and the output voltage Vout from the capacitor C1 can be represented by

Vout=(α/(1−α))Vin+Vin (1)

by letting a be the duty factor of the trigger pulse which is supplied to the FET Q1 by the oscillation circuit OS1.

Therefore, if Vin=5V and Vout=24V as described above, then α=19/24. If the value of α when Vout=2Vin is less than 0.5, a sufficient step-up ratio cannot be obtained, and the effect of improving the heating efficiency by inserting the step-up circuit 7 will be lessened. In this respect, the blade edge 1a is made from a thin metal plate or wire and is very easily induction heated, and α is preferably less than 0.5 when a trigger pulse from the same oscillation circuit OS1 is used.

Patent Document 1: Japanese Patent No. 3652393.

Patent Document 2: Japanese Patent Laid-Open No. 2004-243112.

Patent Document 3: Japanese Patent Laid-Open No. 10-94685.

Patent Document 4: Japanese Patent Laid-Open No. 2004-41782.

Patent Document 5: Japanese Patent Laid-Open No. 2002-246161.

Patent Document 6: Japanese Patent Laid-Open No. 2005-116385.

### DISCLOSURE OF THE INVENTION

It is an object of the present invention to provide a shaver cleaner and shaver system which uses a step-up circuit for improving the efficiency of heating upon drying the blade edge with electromagnetic induction heating allowing to prevent the over heating of the blade edge even if a trigger pulse is shared for electromagnetic induction heating and stepping up of voltage.

The shaver cleaner of the present invention comprises a step-up circuit and a drying part, each of which includes a switch element, further including an inversion part for inverting the trigger pulse supplied to the switch element in the step-up circuit to input the inverted pulse to the switch element in said drying part. Alternatively, the shaver cleaner may comprise, in place of the inversion part, a frequency dividing part for dividing the trigger pulse supplied to the switch element in the step-up circuit to input it into the switch element in the drying part. Accordingly, the shaver system of the present invention comprises such a shaver cleaner, a shaver, and a power supply adapter.

In the shaver cleaner and shaver system of such configuration, the overheating of the blade edge can be prevented even when a trigger pulse is shared for electromagnetic induction heating and voltage stepping up.

### BRIEF DESCRIPTION OF THE DRAWINGS

FIG. 1 is an electric circuit diagram to show a step-up circuit and an electromagnetic induction heating circuit in the shaver system relating to an embodiment of the present invention;

FIG. 2 is an electric circuit diagram to show the step-up circuit and the electromagnetic induction heating circuit in the shaver system relating to another embodiment of the present invention;

FIG. 3 shows the configuration of a shaver system on which the present invention is founded; and

FIG. 4 is an electric circuit diagram to show a typical conventional art step-up circuit and electromagnetic induction heating circuit in the above described shaver system.

### BEST MODE FOR CARRYING OUT THE INVENTION

Hereinafter, an embodiment relating to the present invention will be described with reference to the drawings. It is noted that configurations given like reference characters in each Figure represent like configurations and the description thereof will be omitted.

### Embodiment 1

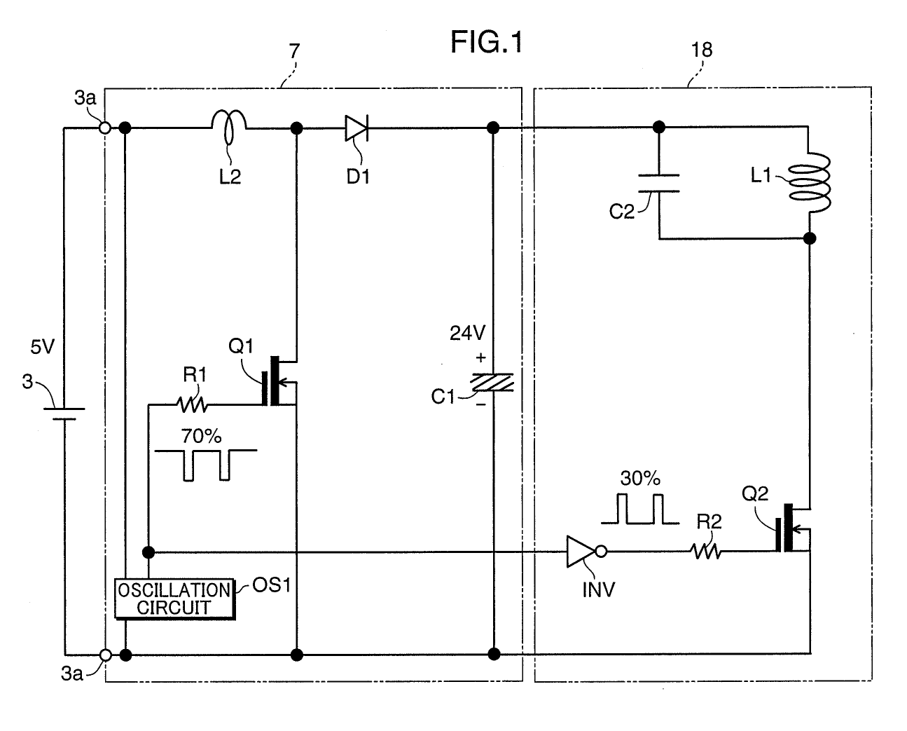

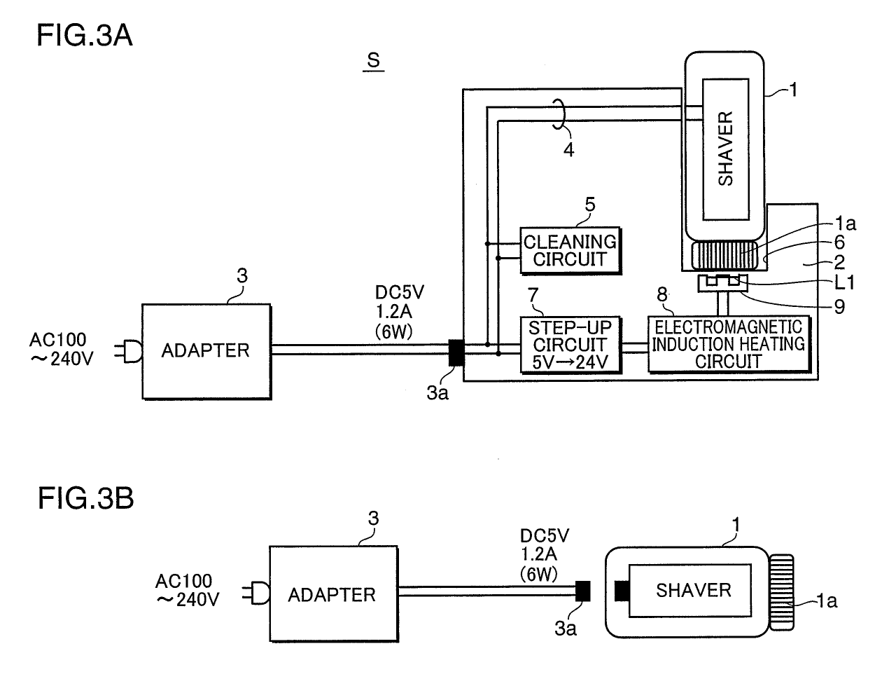

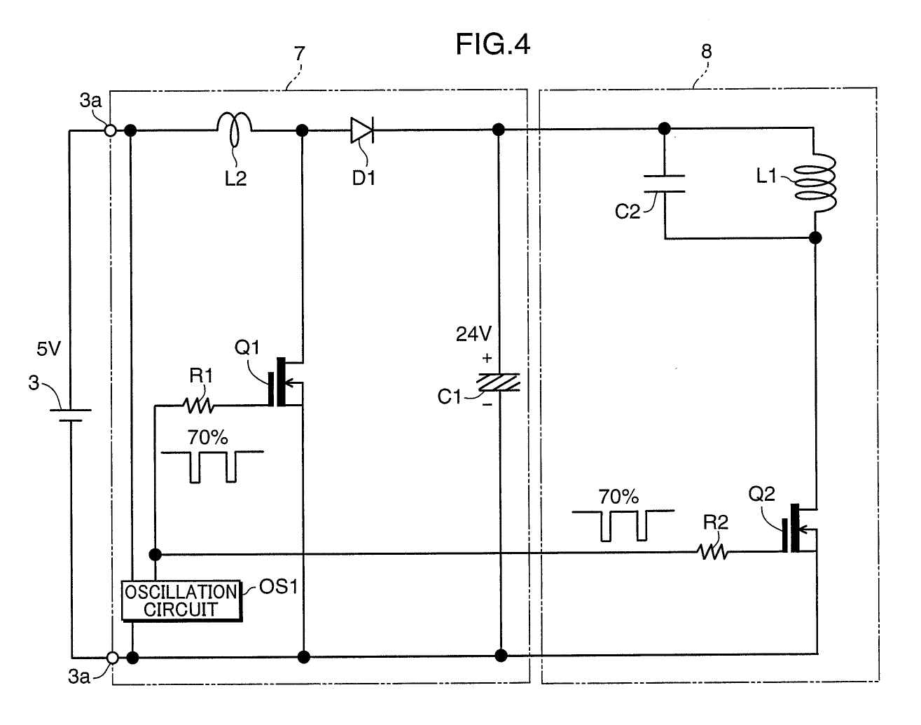

FIG. 1 is an electric circuit diagram of a step-up circuit 7 and an electromagnetic induction heating circuit 18 in the shaver system relating to an embodiment of the present invention. The shaver system S of the present embodiment is configured in roughly the same way as in the above described FIG. 3 to include a shaver 1, a cleaner 2, and an AC adapter 3 and such that power can be supplied at a predetermined DC voltage from the AC adapter 3 to the shaver 1, and power can be supplied at the predetermined DC voltage from the AC adapter 3 to the cleaner 2 as well. In this configuration, the present embodiment is only different in that the electromagnetic induction heating circuit 18 shown in FIG. 1 is used in place of the electromagnetic induction heating circuit 8 of the cleaner 2 shown in FIG. 4 described above, and corresponding configurations are denoted by like reference characters.

In FIG. 1, the step-up circuit 7 comprises a switching-type regulator and is configured to have a power supply input of DC 5V supplied from the terminal 3a of the above described AC adapter 3. A series circuit of a choke coil L2 and an FET Q1 which is a switch element is connected between the terminals 3a. An oscillation circuit OS1 is connected to the gate of the FET Q1 via a gate resistance R1. A series circuit of a diode D1 and a capacitor C1 is connected between the source and the drain of the FET Q1. When a trigger pulse supplied from the oscillation circuit OS1 to the gate of the FET Q1 via the gate resistance R1 becomes a high level, the FET Q1 turns on so that the excitation energy is accumulated in the choke coil L2. Then, when it is turned off, the voltage generated at the choke coil L2 is added to the 5V from the terminal 3a to be outputted; and the voltage is taken out from the connection point of the choke coil L2 and the FET Q1 via the diode D1 to be accumulated in the capacitor C1. Thus, for the above described input voltage of DC 5V, for example DC 24V is outputted across the terminals of the capacitor C1, which is made up of an electrolytic capacitor and serves as the power supply of the electromagnetic induction heating circuit 18.

In the electromagnetic induction heating circuit 18 which is a drying part, the above described capacitor C1 serves as the power supply. A series circuit of a coil L1 and an FET Q2 which is a switch element, is connected between the terminals of the capacitor C1. The oscillation circuit OS1 is connected to the gate of the FET Q2 via an inverter INV and a gate resistance R2. A resonance capacitor C2 is connected in parallel to the coil L1. When a trigger pulse supplied from the oscillation circuit OS1 to the gate of the FET Q2 via the inverter INV and the gate resistance R2 becomes a high level, the FET Q2 turns on so that an eddy current is generated in the blade edge 1a by electromagnetic induction causing the blade edge 1a to generate heat.

It is to be noted that in the present embodiment the trigger pulse supplied from the oscillation circuit OS1 to the FET Q2 has its polarity inverted by the inverter INV which is an inverting part. Therefore, when it is supposed that the duty factor of the trigger pulse outputted from the oscillation circuit OS1, that is, the duty factor for voltage stepping-up is for example 70%, the duty factor for electromagnetic induction heating will be 30%. As the resistance value of the gate resistance R2 increases, the ON timing of the FET Q2 will be delayed allowing the duty factor to be further decreased.

Moreover, the order of the inverter INV and the gate resistance R2 is arbitrary, and the oscillation circuit OS1 may be connected to the gate of the FET Q2 via the gate resistance R2 and the inverter INV.

By configuring as described above, in a shaver system configured such that power can be supplied at the same voltage from the AC adapter 3 to the cleaner 2 as well as to the shaver 1 by replacing the terminal 3a, it is possible to increase the efficiency of electromagnetic induction heating by providing a step-up circuit 7 in the former stage of the electromagnetic induction heating circuit 18 in the cleaner 2. In this respect, since a commercial power supply is used for the power supply voltage in a common electromagnetic induction heating circuit for heating pans and the like, the winding number of the transformer for electromagnetic induction heating can be increased, moreover the current can be started up quickly, and the frequency can be easily increased. However, when a voltage as low as a battery voltage of 5V is used for the power supply, increasing the winding number is difficult, the ON time of the switch element of the electromagnetic induction heating circuit will increase, and the frequency is caused to decrease, resulting in a decline of heating capacity. Therefore, it is suitable to provide the above described step-up circuit 7 in the cleaner 2, which shares the power supply with the shaver 1 such as one of the present embodiment which is operated at a low voltage.

Further, even though the oscillation circuit OS1 is shared between the step-up circuit 7 provided as described above and the electromagnetic induction heating circuit 18, providing the inverter INV will result in that as the duty factor of the trigger pulse supplied to the FET Q1 in the step-up circuit 7 increase, the duty factor of the trigger pulse supplied to the FET Q2 in the electromagnetic induction heating circuit 18 will decrease. Therefore, it is possible to optimize the power conversion in each circuit thereby suppressing the overheating of the blade edge 1a made from thin metal. Further, since the switching frequency in the step-up circuit 7 and that in the electromagnetic induction heating circuit 18 become the same, the number of the noise filters to be used can be reduced and moreover the protection against noise is easy.

It is noted that in the configuration of FIG. 1, the FETs Q1 and Q2 are exemplified by an n-type, it is also contemplated to use a p-type for either one of them thereby omitting the above described inverter INV. When a p-type is used, since it becomes ON state when the power is off, usability is sacrificed, and the n-type is advantageous to withstand voltage as well.

### Embodiment 2

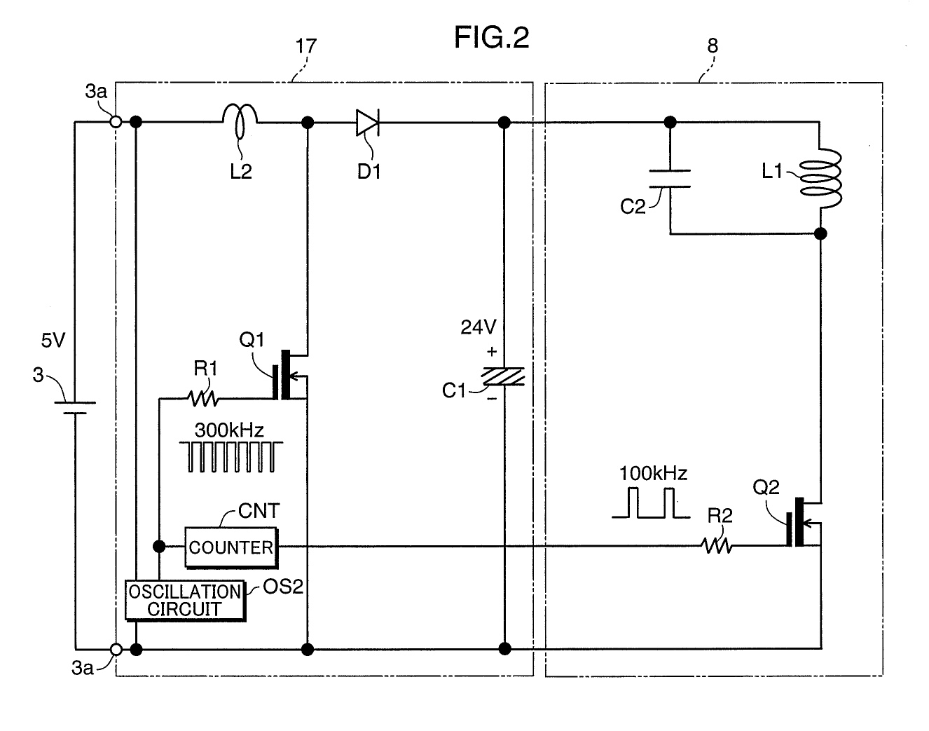

FIG. 2 is an electric circuit diagram to show a step-up circuit 17 and an electromagnetic induction heating circuit 8 in the shaver system relating to another embodiment of the present invention. The shaver system S of the present embodiment is configured in roughly the same way as in the above described FIG. 3 to include a shaver 1, a cleaner 2, and an AC adapter 3 and such that power can be supplied at a predetermined DC voltage from the AC adapter 3 to the shaver 1, and power also can be supplied at the predetermined DC voltage from the AC adapter 3 to the cleaner 2 as well. In this configuration, the present embodiment is only different in that the step-up circuit 17 shown in FIG. 2 is used in place of the step-up circuit 7 of the cleaner 2 shown in the above described FIG. 4, and corresponding configurations are denoted by like reference characters.

In FIG. 2, the step-up circuit 17 also comprises a switching-type regulator and is configured to have a power supply input of DC 5V supplied from the terminal 3a of the above described AC adapter 3. A series circuit of a choke coil L2 and an FET Q1 is connected between the terminals 3a. An oscillation circuit OS2 is connected to the gate of the FET Q1 via a gate resistance R1. A series circuit of a diode D1 and a capacitor C1 is connected between the source and the drain of the FET Q1.

In the electromagnetic induction heating circuit 8, the above described capacitor C1 serves as the power supply. A series circuit of the coil L1 and FET Q2 is connected between the terminals. The oscillation circuit OS2 is connected to the gate of the FET Q2 via a counter CNT and a gate resistance R2. A capacitor C2 is connected in parallel to the coil L1.

It is to be noted that in the present embodiment the trigger pulse supplied from the oscillation circuit OS2 is frequency divided by the counter CNT, which is a frequency dividing part, and is supplied to the FET Q2 of the electromagnetic induction heating circuit 8. The counter CNT is made up of for example a ⅓ frequency divider, in which case, when a trigger pulse for stepping-up supplied from the oscillation circuit OS2 has a duty factor of 70% for example at 300 kHz, the trigger pulse for electromagnetic induction heating circuit 8 will have a duty factor of about 23% at 100 kHz.

Such a configuration also can prevent the overheating of the blade edge 1a made up of thin metal. Further, the switching frequency at the step-up circuit will be an integral multiple of the switching frequency at the electromagnetic induction heating circuit 8, and the protection against noise is easy.

Although the present invention discloses various embodiments as described above, principal inventions among those will be summarized below.

The shaver cleaner relating to a first embodiment includes: a step-up circuit comprising a switching-type regulator, and for stepping up a predetermined DC voltage from a power supply; a drying part comprising a coil for producing an induction field and a switch element connected in series to the coil, and for drying a blade edge of a shaver after being cleaned through electromagnetic induction heating using the voltage stepped up by the step-up circuit; and an inversion part for inverting a trigger pulse supplied to the switch element in the step-up circuit and inputting the inverted pulse into the switch element in the drying part.

The shaver system relating to a second embodiment is configured to include a shaver, a power supply adapter, and a cleaner and such that power can be supplied at a predetermined DC voltage from the power supply adapter to the above described shaver, and power is also supplied at the predetermined DC voltage from the power supply adapter to the cleaner, and a drying part in the cleaner dries the blade edge of the shaver, which has been cleaned, through electromagnetic induction heating using the voltage which has been stepped up by the step-up circuit in the above described cleaner; the shaver system further being configured such that the above described step-up circuit comprises a switching-type regulator, the above described drying part comprises a coil for producing an induction field and a switch element connected in series thereto, and a trigger pulse to the switch element in the above described step-up circuit is inverted and inputted into the switch element in the drying part. The shaver system comprises a shaver, a power supply adapter, and a cleaner and is configured such that power can be supplied at a predetermined DC voltage from the power supply adapter to the shaver, and also power is supplied at the predetermined DC voltage from the power supply adapter to the cleaner, the shaver system being further configured such that the above described cleaner is the shaver cleaner relating to the first embodiment.

According to the above described configuration, the shaver system comprising a shaver, a power supply adapter, and a cleaner is configured such that the power supply adapter can supply power at a predetermined DC voltage suitable for the operation of the shaver, for example, 5V suitable for charging a secondary battery, and also can supply power at the same voltage to the cleaner by replacing the terminal. In such a configuration, when the drying part dries the blade edge of the shaver after being cleaned through electromagnetic induction heating, a lower power supply voltage at the cleaner side will result in an increased loss due to the switch element such as an FET for turning on/of the current to the coil for producing an induction field. In this respect, if the DC voltage itself supplied from the power supply adapter is increased, the shaver will require a step-down circuit thereby being up-sized. For this reason, when a step-up circuit is provided at the cleaner side and the drying part produces an induction field using the voltage after being stepped up, the step-up circuit is made up of a switching-type regulator so that the trigger pulse supplied to the switch element in the step-up circuit is inverted and inputted into the switch element in the drying part.

Therefore, in order to obtain a sufficient step-up ratio, the duty factor of the trigger pulse supplied to the switch element in the step-up circuit increases. Therefore, if the trigger pulse is supplied as it is to the switch element in the drying part, overheating will result. However, by inverting the trigger pulse by an inverter etc. and inputting the inverted pulse, the duty factor of the trigger pulse supplied to the switch element of the drying part will be decreased. Thus, such overheating will be suppressed thereby allowing the sharing of the oscillation part of trigger pulse. Moreover, the switching frequency in the step-up circuit and that in the drying part will become the same and thus the protection against noise becomes easy as well.

The shaver cleaner relating to a third embodiment comprises: a step-up circuit comprising a switching-type regulator, and for stepping up a predetermined DC voltage from a power supply; a drying part comprising a coil for producing an induction field and a switch element connected in series to the coil, and for drying a blade edge after being cleaned through electromagnetic induction heating by using the voltage stepped up by the step-up circuit; and a frequency division part for frequency dividing the trigger pulse supplied to the switch element in the step-up circuit and inputting the frequency divided pulse into the switch element in the drying part. That is, the shaver system is a shaver system relating to the first embodiment comprising in place of the inverter part, a frequency division part for frequency dividing the trigger pulse supplied to the switch element in the step-up circuit and inputting the frequency divided pulse into the switch element in the drying part.

The shaver system relating to a fourth embodiment comprises a shaver, a power supply adapter, and a cleaner and is configured such that power can be supplied at a predetermined DC voltage from the power supply adapter to the shaver, power is also supplied at the predetermined DC voltage from the power supply adapter to the cleaner, and the drying part in the cleaner dries the blade edge of the shaver after being cleaned through magnetic induction heating using the voltage stepped up in the step-up circuit of the cleaner, the shaver system being further configured such that the step-up circuit comprises a switching-type regulator, the drying part comprises a coil for producing an induction field and a switch element connected in series thereto, and a trigger pulse supplied to the switch element in the step-up circuit is frequency divided and inputted into the switch element in the drying part. The shaver system comprises a shaver, a power supply adapter, and a cleaner, and is configured such that power can be supplied at a predetermined DC voltage from the power supply adapter to the shaver, and also power is supplied at the predetermined DC voltage from the power supply adapter to the cleaner, the shaver system being further configured such that the above described cleaner is the shaver cleaner relating to the second embodiment.

According to the above described configuration, the shaver system comprising a shaver, a power supply adapter, and a cleaner is configured such that the power supply adapter can supply power at a predetermined DC voltage suitable for the operation of the shaver, for example, 5V suitable for charging a secondary battery, and also can supply power at the same voltage to the cleaner by replacing the terminal. In such a configuration, when the drying part dries the blade edge of the shaver after being cleaned through electromagnetic induction heating, a lower power supply voltage at the cleaner side will result in an increased loss due to the switch element such as an FET for turning on/of the current to the coil for producing an induction field. In this respect, if the DC voltage itself supplied from the power supply adapter is increased, the shaver will require a step-down circuit thereby being up-sized. For this reason, when a step-up circuit is provided at the cleaner side and the drying part produces an induction field using the voltage after being stepped up, the step-up circuit is made up of a switching-type regulator so that the trigger pulse supplied to the switch element in the step-up circuit is frequency divided with a counter etc. and inputted into the switch element in the drying part.

Therefore, in order to obtain a sufficient step-up ratio, the duty factor of the trigger pulse supplied to the switch element in the step-up circuit increases. Therefore, if the trigger pulse is supplied as it is to the switch element in the drying part, overheating will result. However, by frequency dividing the trigger pulse and inputting the frequency divided pulse, the frequency of the trigger pulse supplied to the switch element of the drying part will be decreased even when the ON period of the trigger pulse is unchanged. Thus, such overheating will be suppressed thereby allowing the sharing of the oscillation part of trigger pulse. Moreover, the switching frequency in the step-up circuit will become an integer multiple of that of the drying part and thus the protection against noise becomes easy as well.

In order to represent the present invention, although the present invention has been described appropriately and sufficiently through embodiments described above with reference to the drawings, those skilled in the art should recognize that modifications and/or improvements can be readily made to the above described embodiments. Therefore, it is intended that the modifications or improvements made by those skilled in the art are included within the scope of relevant claims as long as they do not depart from the scope of the claims.

### INDUSTRIAL APPLICABILITY

According to the present invention, it is possible to provide a shaver cleaner and a shaver system which allow the sharing of the trigger pulse used for electromagnetic induction heating and voltage step-up.

1. A shaver cleaner, characterized by comprising:
a step-up circuit comprising a switching type regulator, and for stepping up a predetermined DC voltage from a power supply;
a drying part comprising a coil for producing an induction field and a switch element connected in series to said coil, and for drying a blade edge of a shaver after being cleaned through electromagnetic induction heating using the voltage stepped up by said step-up circuit; and
an inversion part for inverting a trigger pulse to the switch element in the step-up circuit and inputting the inverted pulse into the switch element in the drying part.

2. The shaver cleaner according to claim 1, characterized by comprising, in place of the inversion part, a frequency dividing part for frequency dividing a trigger pulse supplied to the switch element in the step-up circuit and inputting the frequency divided pulse into the switch element in the drying part.

3. A shaver system comprising a shaver, a power supply adapter, and a cleaner and configured such that power can be supplied at a predetermined DC voltage from the power adapter to the shaver, and power also can be supplied at the predetermined DC voltage from said power supply adapter to said cleaner, said shaver system characterized in that the cleaner is the shaver cleaner according to claim 1.

4. A shaver system comprising a shaver, a power supply adapter, and a cleaner and configured such that power can be supplied at a predetermined DC voltage from the power adapter to the shaver, and power also can be supplied at the predetermined DC voltage from said power supply adapter to said cleaner, said shaver system characterized in that the cleaner is the shaver cleaner according to claim 2.
